(19) United States
(12) Patent Application Publication
(10) Pub. No.: US 2026/0080071 A1
(43) Pub. Date: Mar. 19, 2026

(54) PROTECTING SENSITIVE DATA IN CONFIDENTIAL COMPUTING

(71) Applicant: International Business Machines Corporation, Armok, NY (US)

(72) Inventors: Wen Yi Gao, Beijing (CN); Xian Wei Zhang, Beijing (CN); Zhi Dan Hao, Beijing (CN); Chen Guang Liu, Beijing (CN); XiangXing Shi, Beijing (CN)

(21) Appl. No.: 18/886,746

(22) Filed: Sep. 16, 2024

(51) Int. Cl. G06F 21/60; G06F 9/455

(52) U.S. Cl. CPC G06F 21/602; G06F 9/45558; G06F 2009/45583

(57) ABSTRACT

A method, in one general approach, includes: receiving a secret deployment request from a user. The secret deployment request is encrypted using a private key correlated with the user. Moreover, an encrypted version of the private key correlated with the user is stored in a hyper protect virtual machine based container. The method also includes storing the encrypted secret deployment request in memory.

### BACKGROUND

The present invention relates to cryptographic keys, and more specifically, this invention relates to using cryptographic keys to protect sensitive data.

Data production has continued to increase, particularly as computing power and the use of IoT devices advance. For instance, the rise of smart enterprise endpoints and local data management has led to large amounts of data being generated and managed at remote locations. Data production will only further increase with the growth of 5G networks and an increased number of devices that are connected to the networks.

This issue of data management has also become more prevalent as the complexity of machine learning models increases. Increasingly complex machine learning models translate to more intense workloads and increased strain associated with training the models using large data sets and even applying the trained models to received data. The operation of conventional implementations has thereby been negatively impacted.

While cloud computing has been implemented in some conventional systems in an effort to improve the ability to process this increasing amount of data, moving sensitive data and workloads to the cloud exposes them to security risks. For example, the process of moving certain data and/or workloads to cloud for computation efficiency assumes (e.g., requires) the cloud to be secure. Cryptography allows for some security to be introduced to workloads and data that are exposed to public environments, but has also introduced unique security risks.

For example, conventional software that is used at least in part to deploy containerized applications store information in an unencrypted form. This allows for any entity (e.g., user, application, etc.) that has access to a corresponding application programming interface (API) to freely retrieve and/or modify any of the sensitive information while in storage. This is also true for entities that have access to the memory in which the sensitive information is stored.

### SUMMARY

A method, in one general approach, includes: receiving a secret deployment request from a user. The secret deployment request is encrypted using a private key correlated with the user. Moreover, an encrypted version of the private key correlated with the user is stored in a hyper protect virtual machine based container. The method also includes storing the encrypted secret deployment request in memory.

A computer program product, according to another general approach, includes: one or more computer-readable storage media. The computer program product also includes program instructions that are stored on the one or more storage media to perform any combination(s) of the foregoing methodologies.

A computer system, according to yet another general approach, includes: a processor set, and one or more computer-readable storage media. The computer system also includes program instructions that are stored on the one or more storage media to cause the processor set to perform any combination(s) of the foregoing methodologies.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2A is a representational view of a distributed system, in accordance with one approach.

FIG. 2B is a representational view of a having a cloud based application environment, in accordance with one approach.

FIG. 2C is a representational view of a hyper protect virtual machine based container, in accordance with one approach.

FIG. 3A is a flowchart of a method, in accordance with one approach.

FIG. 3B is a representational view of securing various cryptographic keys, in accordance with one approach.

FIG. 4A is a flowchart of a method, in accordance with one approach.

FIG. 4B is a representational view of performing a secret pod deployment, in accordance with one approach.

FIG. 4C is a representational view of performing a user specific key deployment, in accordance with one approach.

FIG. 4D is a representational view of accessing encrypted sensitive data, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods, and computer program products for providing a cloud native process of improving the security with which sensitive data is protected. For instance, by implementing user specific keys to encrypt different sensitive data, approaches herein significantly improve data security. It follows that sensitive data corresponding to a given user is encrypted by a user specific key (e.g., a user specific private key) before the sensitive data is stored in memory. This allows for sensitive data to be cryptographically protected in a manner that is unique to each user, thereby desirably increasing data security. The keys assigned to the respective users are also protected in a hyper protect secret service virtual machine based container that may further be running in a secure execution environment. Accordingly, only the proper user and other authorized entities (e.g., users, applications, controllers, processors, etc.) are able to access a respective one of the user owned keys from the hyper protect secret service virtual machine based container, e.g., as will be described in further detail below.

In one general approach, a method includes: receiving a secret deployment request from a user. The secret deployment request is encrypted using a private key correlated with the user. Moreover, an encrypted version of the private key correlated with the user is stored in a hyper protect virtual machine based container. The method also includes storing the encrypted secret deployment request in memory.

Approaches herein are thereby able to provide a cloud native method to protect user sensitive data. This is true even in systems that implement software that is used at least in part to deploy containerized applications, which has been particularly difficult for conventional products to achieve. For instance, utilizing user specific (e.g., user owned) encryption keys allows for sensitive data corresponding to a given user to be encrypted by a user specific key before the sensitive data is stored in memory. This allows for sensitive data to be cryptographically protected in a manner that is unique to each user, thereby desirably increasing data security. The keys assigned to the respective users are also protected in a hyper protect secret service virtual machine based container that may further be running in a secure execution environment. Accordingly, only the proper user and other authorized entities are able to access a respective one of the user owned keys from the hyper protect secret service virtual machine based container.

In some implementations, encrypting the secret deployment request using a private key correlated with the user includes: sending one or more instructions to the hyper protect virtual machine based container. The one or more instructions cause a webhook to encrypt data in the secret deployment request using the private key correlated with the user. The webhook may include an HTTP-based callback function which allows for lightweight, event-driven communication to occur between two APIs. The webhook may thereby be able to work with an encryption engine in some instances to achieve the data encryption. This allows for the encryption to happen automatically (e.g., without specific input from a user), reducing overall latency.

In some implementations, storing an encrypted version of the private key correlated with the user in a hyper protect virtual machine based container includes: encrypting the private key correlated with the user, using a public key in a cryptographic key pair associated with the hyper protect virtual machine based container. This desirably allows for the private key assigned to a given user—and which was used to perform the encryption—to itself be stored in an encrypted form. This further improves data security and retention. Additionally, those with access to the private key of the cryptographic key pair associated with the hyper protect virtual machine based container to decrypt the user specific private key.

In some implementations, the method further includes: receiving a request for the encrypted secret deployment request. In response to receiving the request, an init container is injected into a newly deployed pod. The init container may be injected by sending one or more instructions to the hyper protect virtual machine based container, the one or more instructions causing a webhook to inject the init container into the newly deployed pod. The encrypted secret deployment request is also pulled into the newly deployed pod, and the encrypted secret deployment request is decrypted.

In some implementations, the process of decrypting the encrypted secret deployment request includes: using a private key in a cryptographic key pair associated with the hyper protect virtual machine based container to decrypt the encrypted version of the private key correlated with the user. The process also includes using the decrypted version of the private key correlated with the user to decrypt data in the encrypted secret deployment request.

As noted above, using a public key in a cryptographic key pair associated with the hyper protect virtual machine based container to encrypt the private key assigned to a given user further improves data security and retention. Additionally, those with access to the private key of the cryptographic key pair associated with the hyper protect virtual machine based container to decrypt the user specific private key. This allows for a centralized private key to access information specific to each user.

In some implementations, the memory includes a key-value store. Moreover, the secret deployment request may be received from the user at an API server of a cloud based application system. The hyper protect virtual machine based container further includes an image built in a secure environment at the cloud based application system. The image secures a private key in a cryptographic key pair associated with the hyper protect virtual machine based container.

It follows that approaches herein are desirably able to protect user specific cryptographic keys in a hyper protect image. As noted above, in some approaches the hyper protect image is a QCOW2 image that is built in a secure environment. The image may thereby secure (e.g., protect) a private key in a cryptographic key pair associated with the hyper protect virtual machine based container. The hyper protect image may also include the private key in the key pair that is associated with the hyper protect secret service virtual machine based container. Moreover, the initrd and bootloader may be encrypted by an image key that is generated automatically in the secure build environment. Approaches herein are thereby able to increase the security with which private keys are stored and maintained, while also ensuring quick and easy access for authorized users.

In another general approach, a computer program product includes: one or more computer-readable storage media. The computer program product also includes program instructions that are stored on the one or more storage media to perform any combination(s) of the foregoing methodologies.

In yet another general approach, a computer system includes: a processor set, and one or more computer-readable storage media. The computer system also includes program instructions that are stored on the one or more storage media to cause the processor set to perform any combination(s) of the foregoing methodologies.

In still another general approach, a method includes receiving a request to create a KUBERNETES Secret and store user sensitive data therein may be received from the user that owns (e.g., is authorized to possess) the sensitive data. The user sensitive data may be received in encrypted form, e.g., using a user specific private key. In addition to the encrypted sensitive user data, the user may also provide the user specific private key in encrypted form. Specifically, the user specific key may be encrypted with the public key of a cryptographic key pair associated with the hyper protect virtual machine based container. Thus, the user specific key may be decrypted using the private key of the cryptographic key pair associated with the hyper protect virtual machine based container, thereby providing access to the encrypted user sensitive data stored in the KUBERNETES Secret.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved data protection code at block 150 for providing a cloud native process of improving the security with which sensitive data is protected. For instance, by implementing user specific keys to encrypt different sensitive data, approaches herein significantly improve data security. It follows that sensitive data corresponding to a given user is encrypted by a user specific key (e.g., a user specific private key) before the sensitive data is stored in memory. This allows for sensitive data to be cryptographically protected in a manner that is unique to each user, thereby desirably increasing data security. The keys assigned to the respective users are also protected in a hyper protect secret service virtual machine based container that may further be running in a secure execution environment. Accordingly, only the proper user and other authorized entities (e.g., users, applications, controllers, processors, etc.) are able to access a respective one of the user owned keys from the hyper protect secret service virtual machine based container, e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and IoT sensor set 125), and network module 115. Remote server 104 includes remote database 130. Public cloud 105 includes gateway 140, cloud orchestration module 141, host physical machine set 142, virtual machine set 143, and container set 144.

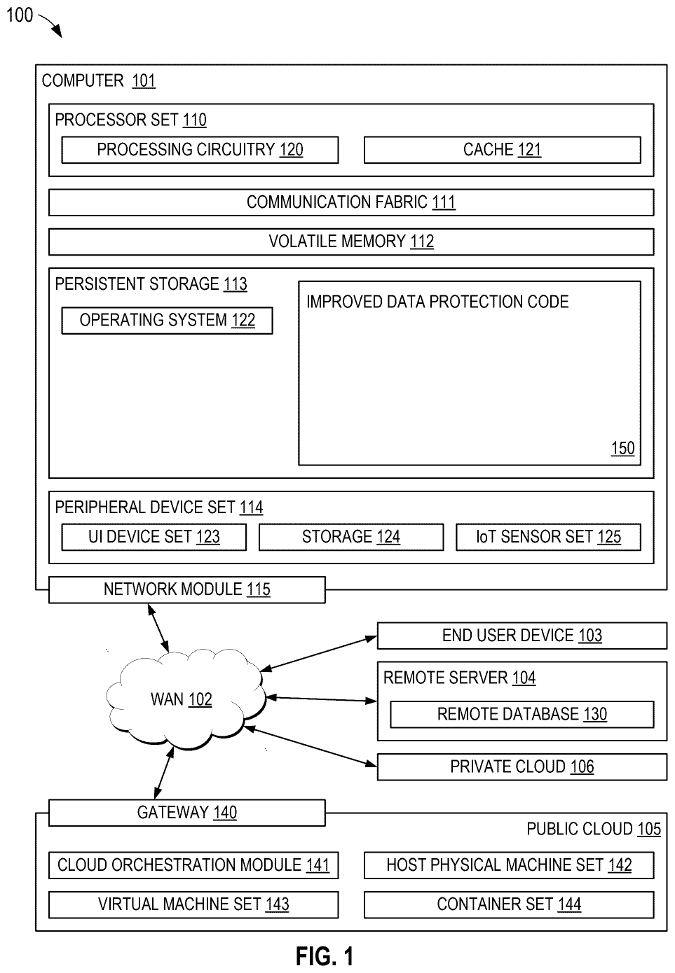

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, data production has continued to increase, particularly as computing power and the use of IoT devices advance. For instance, the rise of smart enterprise endpoints and local data management has led to large amounts of data being generated and managed at remote locations. Data production will only further increase with the growth of 5G networks and an increased number of devices that are connected to the networks.

This issue of data management has also become more prevalent as the complexity of machine learning models increases. Increasingly complex machine learning models translate to more intense workloads and increased strain associated with training the models using large data sets and even applying the trained models to received data. The operation of conventional implementations has thereby been negatively impacted.

While cloud computing has been implemented in some conventional systems in an effort to improve the ability to process this increasing amount of data, moving sensitive data and workloads to the cloud exposes them to significant security risks. For example, the process of moving certain data and/or workloads to cloud for computation efficiency assumes (e.g., requires) the cloud to be secure. Cryptography allows for some security to be introduced to workloads and data that are exposed to public environments, but has also introduced unique security risks that have plagued conventional products.

For example, conventional software that is used at least in part to deploy containerized applications store information in an unencrypted form. Conventional products have thereby suffered from data exposures and data loss that stem from storing sensitive information (e.g., such as passwords, keys, tokens, etc.) in an unencrypted form. This allows for any entity (e.g., user, application, etc.) that has access to a corresponding API to freely retrieve and/or modify any of the sensitive information while in storage. This is also true for entities that have access to the memory in which the sensitive information is stored.

While attempts have been made to improve the security and retention of sensitive information, these attempts have actually caused more issues than they have resolved. For instance, attempts to encrypt sensitive information using an external key management service actually require that the encryption key is shared by all users in the same cluster. Each of the users in a cluster are thereby equipped to access the sensitive information owned by all other users in the same cluster, thereby significantly increasing exposure of the sensitive data. These attempts have also introduced the use of a new credential to access the external key management service, which in turn further increases the risk of sensitive data exposure.

In sharp contrast to these conventional shortcomings, approaches herein are able to provide a cloud native method to protect user sensitive data. This is true even in systems that implement software that is used at least in part to deploy containerized applications, which has been particularly difficult for conventional products to achieve. It should be noted that while approaches herein are described in the context of KUBERNETES-based cloud application environments, this is in no way intended to be limiting. Approaches herein may thereby be implemented the same, similarly, or differently in systems that deploy any desired type of containerized applications, e.g., as would be appreciated by one skilled in the art after reading the present description.

Approaches herein utilize user specific (e.g., user owned) encryption keys to encrypt sensitive data. It follows that sensitive data corresponding to a given user is encrypted by a user specific key (e.g., a user specific private key) before the sensitive data is stored in memory. This allows for sensitive data to be cryptographically protected in a manner that is unique to each user, thereby desirably increasing data security. The keys assigned to the respective users are also protected in a hyper protect secret service virtual machine based container that may further be running in a secure execution environment. Accordingly, only the proper user and other authorized entities (e.g., users, applications, controllers, processors, etc.) are able to access a respective one of the user owned keys from the hyper protect secret service virtual machine based container. Similarly, encrypted sensitive data is added to a deployed pod and decrypted, e.g., in response to receiving a request to do so.

The encryption and decryption of the sensitive data preferably occurs in the background and is transparent to users. It should also be noted that the term “sensitive data” as used herein refers to information for which access to the data is to be restricted and/or controlled in some way. For instance, a sensitive data may be used in processes that are susceptible to cyberattacks, e.g., such as a password authentication process on a computer system. Depending on the approach, sensitive data may include confidential data, data that is to remain within an organization and not shared outside the organization, data that is not to be made available to the public, data that a user wishes to keep private, data that is subject to a higher standard of care as a result of applicable legislation and/or corporate policies (e.g., data associated with children under 13 years of age as specified by the Children's Online Privacy Protection Act), data that is provided confidentially to another user or entity, etc. In some approaches, certain computing tasks and/or applications are designated by a user, application developer, system administrator, etc., as sensitive tasks that utilize sensitive data.

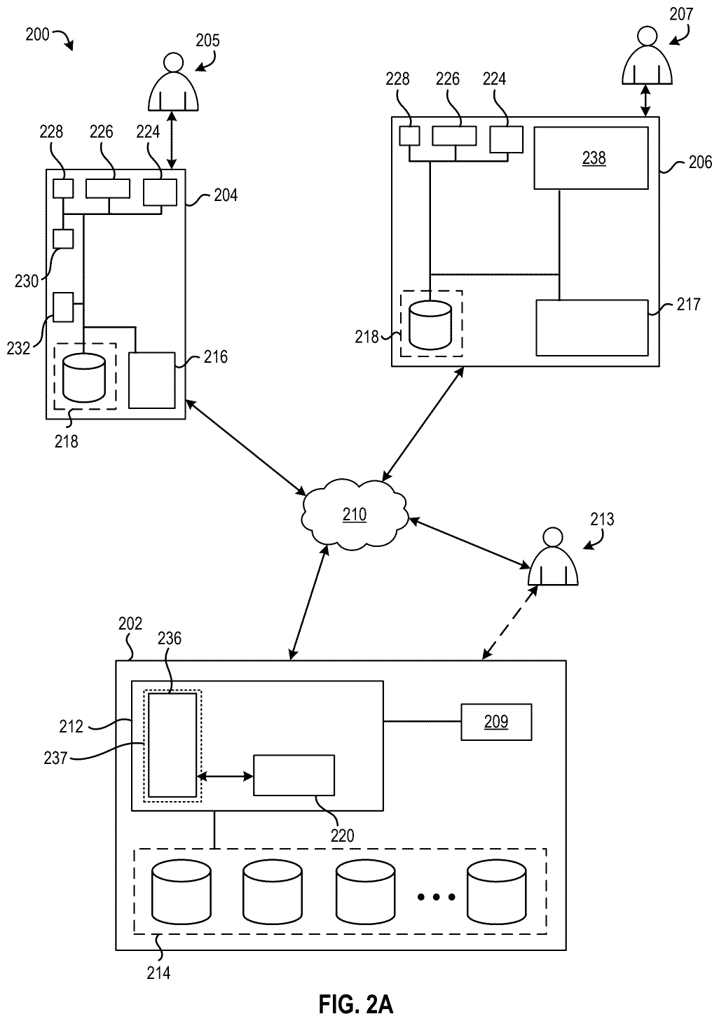

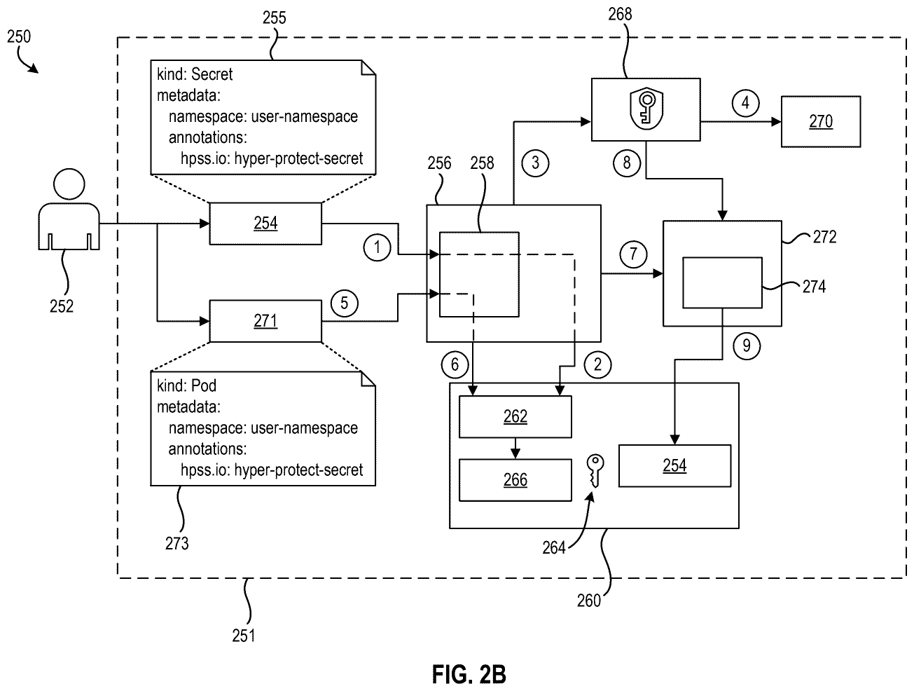

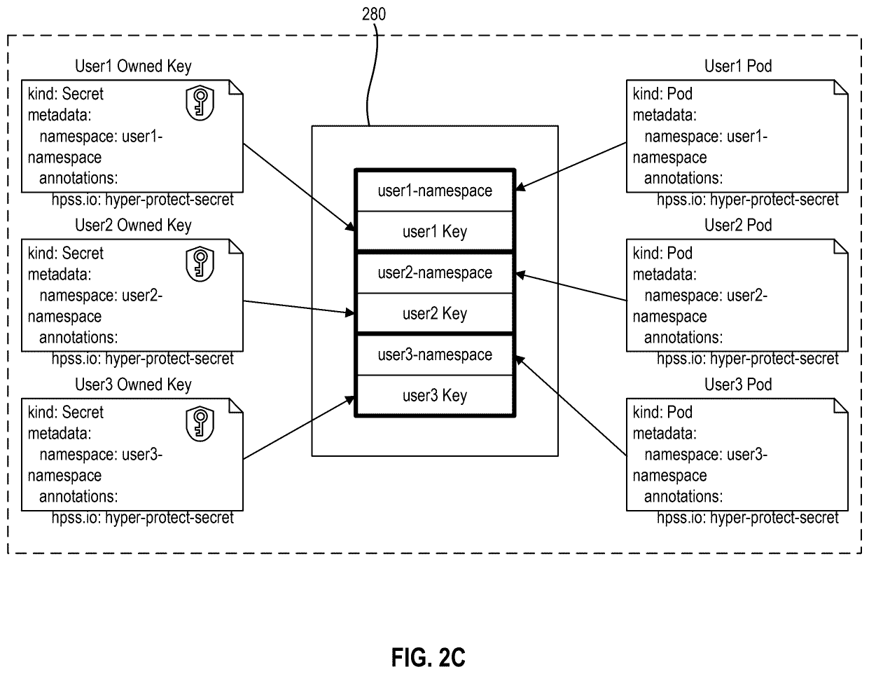

Looking now to FIG. 2A, a distributed data storage system 200 in accordance with one approach. As an option, the present system 200 may be implemented in conjunction with features from any other approach listed herein, such as those described with reference to the other FIGS. However, this distributed data storage system 200 and others presented herein may be used in various applications and/or in permutations which may or may not be specifically described in the illustrative approaches or implementations listed herein. Further, the system 200 presented herein may be used in any desired environment. Thus FIG. 2A (and the other FIGS.) may be deemed to include any possible permutation.

As shown, the distributed data storage system 200 includes a central server 202 that is connected to user device 204 and edge node 206. Specifically, the central server 202, user device 204, and edge node 206 are connected to a network 210 that allows for data (e.g., information, commands, requests, instructions, responses, encrypted data, etc.) to be sent between any of the locations 202, 204, 206.

The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between the locations 202, 204, 206, regardless of the amount of separation which exists therebetween, e.g., despite being positioned at different geographical locations. It should also be noted that the different locations 202, 204, 206 may be connected to each other (and/or other locations) differently depending on the approach. According to an example, two host locations may be located relatively close to each other and connected by a wired connection, e.g., a cable, a fiber-optic link, a wire, etc.; etc., or any other type of connection which would be apparent to one skilled in the art after reading the present description.

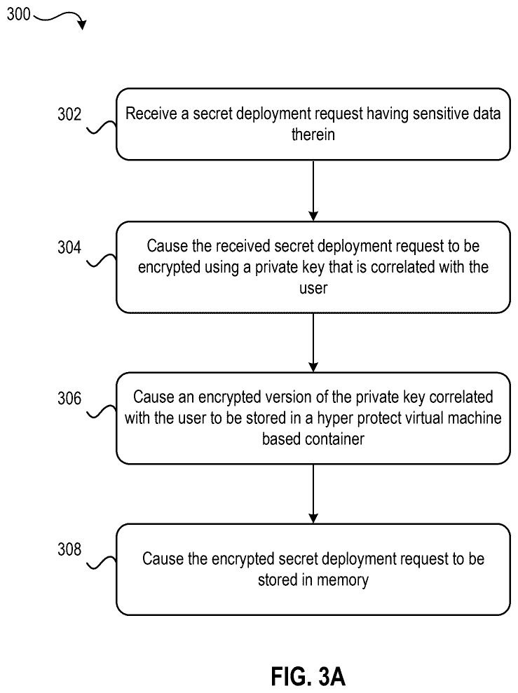

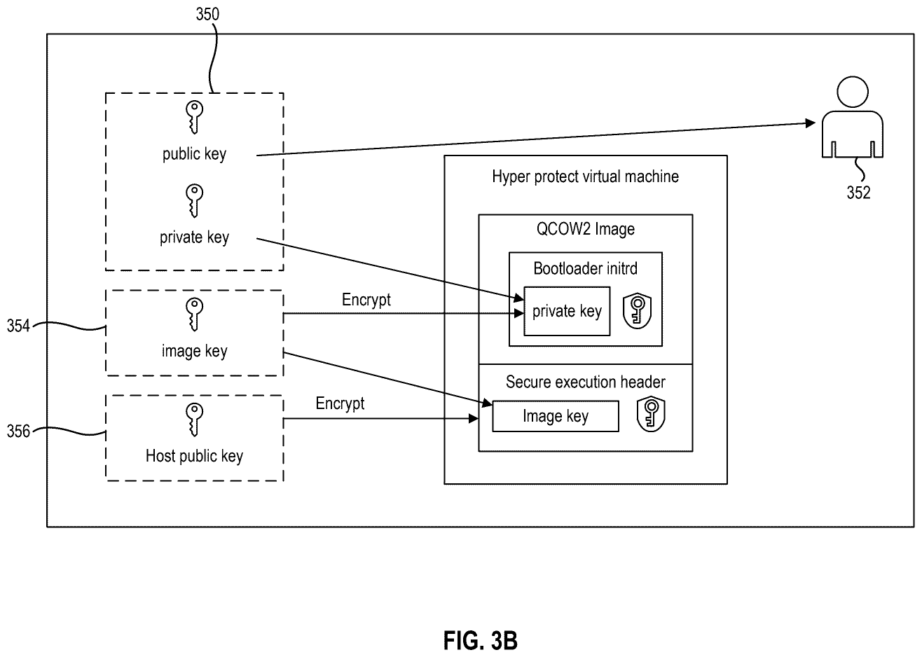

With continued reference to FIG. 2A, the central server 202 includes a large (e.g., robust) processor 212 coupled to a cache 209 and memory 214 having a relatively high storage capacity. The central server 202 is thereby able to process and store a relatively large amount of data, allowing it to be connected to, and manage, multiple different remote locations. Moreover, in some approaches the central server 202 may generate or receive cryptographic keys for each supported user. For instance, user specific cryptographic private keys may be received from the respective users themselves, an encryption engine, a secure software environment (e.g., see secure software environment 236), etc. The central server 202 may thereby assign a unique cryptographic private key to each user, each unique cryptographic private key being configured to encrypt sensitive data that corresponds to the respective user. The processor 212 and/or the secure software environment 236 therein may be used to perform one or more operations in method 300 of FIG. 3A below.

It should also be noted that in some approaches, edge node 206 may generate and/or receive cryptographic keys for one or more respective users. Edge node 206 may thereby assign a unique cryptographic private key to each user that is used to encrypt sensitive data associated with the respective user. In some implementations, the user specific keys are stored and/or managed in a secure software environment at the edge node 206. In other implementations, the user specific keys may be generated at the edge node 206 and transmitted to the central server 202 for storage, management, review, etc. It follows that the edge node 206 itself may include a secure software environment in some approaches. For example, the controller 217 may include a secure software environment therein, e.g., as would be appreciated by one skilled in the art after reading the present description. The AI module 238, controller 217, and/or a secure software environment therein (not shown) may be used to perform one or more operations in method 300 of FIG. 3A below.

With continued reference to FIG. 2A, the secure software environment 236 may be designed (e.g., custom built) to have certain characteristics and/or functionality. For instance, the secure software environment 236 may be used to generate and/or store at least one cryptographic key that is specific to each respective authorized user. The secure software environment may be modified as desired, e.g., to apply one or more encryption and/or decryption keys, add trusted (compliant) hashing algorithm details, etc. In some approaches, the secure software environment is a plugin-based software package that is modified by a host and sent to central server 202 for implementation. For instance, the processor 212 may use the secure software environment 236 to process incoming user sensitive data that is encrypted. However, the secure software environment 236 may only be accessed by a secure engine 220, and is inaccessible to a remainder of the processor 212. In other words, a logical boundary 237 may only be crossed by secure engine 220, and the logical boundary 237 prevents any other aspects of the processor 212 from accessing the secure software environment 236 and any information therein. Software being run outside the logical boundary 237—other than any software running in the secure engine 220—is thereby unable to directly access any data being processed by software running in the secure software environment 236.

The ability to insulate the secure software environment 236 from exterior access effectively hides any cryptographic information, data, etc., that is sent to and/or generated at the secure software environment 236. Thus, although the secure software environment 236 is located at the central server 202, it may implement confidential details without exposing them to the central server 202 and/or entities connected thereto, e.g., such as administrator 213. Any user specific cryptographic keys and/or encrypted user sensitive data that is stored in the secure software environment 236 may thereby be protected against nefarious access attempts, e.g., as will be described in further detail below.

In one example, each of the user specific cryptographic keys may actually correspond to (e.g., be part of) a pair of cryptographic keys. As noted above, each key pair may be specific to a respective user and may include a private key and public key pair configured to encrypt sensitive data (e.g., secret deployment requests having sensitive data), e.g., using one or more APIs. In another example, each of the user specific cryptographic keys may be used in the process of encrypting and/or decrypting stored data according to a given encryption standard. The secure software environment 236 may thereby be able to decrypt encrypted data and process (e.g., deduplicate and/or compress) the decrypted data without exposing any of the sensitive data and/or private key information to a remainder of the processor 212. Similarly, the secure software environment 236 may be able to provide access to physical and/or logical data encryption components without exposing any of the decrypted data and/or private key information to a remainder of the processor 212., e.g., as would be appreciated by one skilled in the art after reading the present description. Implementing the secure software environment 236 in the processor 212 thereby allows for increased storage capacity and reduced compute overhead, while also maintaining strict data security.

With continued reference to FIG. 2A, user device 204 may be a mobile phone that includes a processor 216 coupled to memory 218. The processor 216 may receive inputs from, and interface with, user 205. For instance, the user 205 may input information using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc.

Moreover, edge node 206 includes some of the same or similar components as those included in other locations of system 200, and have therefore been given corresponding numbering. For instance, controller 217 is coupled to memory 218, a display screen 224, keys of a computer keyboard 226, and a computer mouse 228, which are accessible to administrator 207, e.g., at a built-in computer terminal for the edge node 206. Additionally, the controller 217 is coupled to an AI module 238. The AI module 238 may include any desired number and/or type of AI-based models, e.g., such as machine learning models, deep learning models, neural networks, etc. Moreover, the models may be trained to perform certain procedures (e.g., identify patterns), e.g., as would be appreciated by one skilled in the art after reading the present description.

Referring now to FIG. 2B, progressions associated with encrypting and decrypting user sensitive data are depicted in a system 250 having a cloud based application environment in accordance with one approach. In some implementations, the system 250 is a KUBERNETES-based cloud application environment. However, system 250 may utilize any desired type of containerized applications in other implementations. As an option, the present system 250 may be applied in conjunction with features from any other approach listed herein, such as those described with reference to the other FIGS., e.g., such as FIG. 2A. However, this distributed data storage system 250 and others presented herein may be used in various applications and/or in permutations which may or may not be specifically described in the illustrative approaches or implementations listed herein. Further, the system 250 presented herein may be used in any desired environment. Thus FIG. 2B (and the other FIGS.) may be deemed to include any possible permutation.

The progression in FIG. 2B may be used to protect user sensitive data which may be presented as (e.g., included in) secret containers. For instance, the user sensitive data may be inserted into one or more built-in objects that allow users to store and manage sensitive information in a secure way. As shown, this is achieved by a user 252 submitting a secret deployment request 254 having data therein. See operation (1). The secret deployment request 254 is thereby received at an API server 256 of a cloud based application environment 251. The data that may be included in the received secret deployment request 254 is also illustrated in window 255 according to one example which is in no way intended to be limiting.

In response to receiving the secret deployment request 254, the API server 256 causes the secret deployment request and any data therein to be encrypted using a private key (also referred to herein as a “secret key”) that is correlated with the user. See operation (2). Accordingly, one or more instructions are sent from a mutating admission application 258 running in the API server 256, to a hyper protect virtual machine based container 260. Specifically, the one or more instructions result in (e.g., cause) a webhook 262 in the hyper protect virtual machine based container 260 to encrypt data in the received secret deployment request 254 using the specific private key 264 that is correlated with the user 252 that issued the secret deployment request 254. For instance, the webhook 262 may work in combination with an encryption engine to produce the encrypted secret deployment request 266.

As noted above, each user has a unique private key which allows the users to encrypt their respective secret deployment requests (and data therein) differently. This prevents users that may be connected to a same API server 256 from accessing any secret deployment requests and/or sensitive data therein that have been encrypted using a different user's specific key. Moreover, by utilizing a virtual machine based container, approaches herein are able to further protect the secret deployment request and sensitive data therein by further limiting access thereto. It should also be noted that a “webhook” as used herein may include an HTTP-based callback function which allows for lightweight, event-driven communication to occur between two APIs. However, other types of webhooks that would be apparent to one skilled in the art after reading the present description may be used to perform the encryption of the secret deployment request and data therein.

Referring momentarily to FIG. 2C, an exemplary hyper protect virtual machine based container 280 is illustrated in accordance with one approach. As an option, the present hyper protect virtual machine based container 280 may be applied in conjunction with features from any other approach listed herein, such as those described with reference to the other FIGS., e.g., such as FIG. 2B. However, this hyper protect virtual machine based container 280 and others presented herein may be used in various applications and/or in permutations which may or may not be specifically described in the illustrative approaches or implementations listed herein. Further, the hyper protect virtual machine based container 280 presented herein may be used in any desired environment. Thus FIG. 2C (and the other FIGS.) may be deemed to include any possible permutation.

As shown, a number of user specific keys are stored along with the respective user information. For example, user1-namespace is correlated with the respective user1 key. Moreover, User1 Pod illustrates exemplary details that may be included in the user1-namespace. These details in the User1 Pod may be used in some approaches to verify the identity of a user attempting to access the user1 key. In response to access being given to the user1 key, it may be used to encrypt and/or decrypt corresponding sensitive data. For example, details that may be included in the User1 Owned Key may be used by an encryption engine to encrypt and/or decrypt a secret deployment request.

Accordingly, different users will be limited to access their respective private keys and corresponding resources that are associated with the user owned namespaces. In some approaches, users may be able to access their private keys and utilize the corresponding resources using role based access control (RBAC). The RBAC may thereby involve managing access to the private keys and corresponding resources by assigning roles to users and granting permissions to those different roles. Implementing RBAC may thereby assist with improving security, compliance, and operational efficiency of the overarching system, e.g., as would be appreciated by one skilled in the art after reading the present description.

Referring back now to FIG. 2B, operation (3) includes inserting the encrypted secret deployment request (and data therein) into a protected object 268. In preferred approaches, the protected object 268 is a KUBERNETES Secret configured to prevent unauthorized access to the encrypted details therein. Thus, while conventional products have been unable to securely store sensitive information in objects like KUBERNETES Secrets, approaches herein overcome this issue by implementing user specific encryption keys in combination with API servers and the hyper protect virtual machine based container that is configured to combine the two, e.g., as described herein.

According to one example, encrypted user sensitive data may be inserted into and stored in various KUBERNETES Secrets. In other words, one or more instructions may be sent from a controller (e.g., KUBERNETES API server) that result in encrypted user sensitive data being stored in KUBERNETES secret objects. As noted above, this is achieved at least in part by implementing user specific (e.g., user owned) encryption keys to encrypt user sensitive data for the respective users. In other words, user sensitive data is encrypted by private encryption keys that are specific to the respective users that produced (e.g., owned, possessed, etc.) the user sensitive data. Moreover, the user specific (e.g., user owned) keys are protected in (e.g., encrypted using a public key from a cryptographic key pair assigned to) a Hyper Protect Secret Service virtual machine based container. Accordingly, the user specific keys are inaccessible outside the application environment hosting the secure execution environment. This desirably increases security of the user sensitive data, particularly in comparison to conventional issues experienced by storing sensitive data with inadequate or even nonexistent protection, e.g., as will be described in further detail below.

As referred to herein, a KUBERNETES Secret refers to an object that contains sensitive data, e.g., such as a password, a token, a key, etc., or any other user sensitive data. KUBERNETES Secrets thereby allow a user to avoid including confidential data in application code. Moreover, because KUBERNETES Secrets can be created independently of the pods that use them, there is significantly less risk of a Secret (and the sensitive data therein) being exposed during the workflow of creating, viewing, and editing Pods. KUBERNETES and/or other applications that run in a given cluster can also take additional precautions with the Secrets to improve data protection, e.g., such as avoiding writing sensitive data to non-volatile storage. In some approaches, KUBERNETES Secrets are similar to ConfigMaps but are specifically configured to hold confidential data.

Proceeding to operation (4), the protected object 268 (e.g., KUBERNETES Secret) and encrypted content thereof are stored in memory 270. In some approaches, the memory 270 includes a key-value store or database which is used to actually store the protected object 268. According to an example, the memory 270 includes an etcd key-value store to secure the protected objects and sensitive data therein. As previously mentioned, while any users with access to the API server 256 that is connected to the memory 270 may be able to access the protected object 268 (and others) therein, only users with access to the specific key used to encrypt the protected object 268 may actually decrypt the data and gain control of it.

For instance, operation (5) includes receiving a request 271 for the secret deployment request originally received in operation (1) and data therein. The request 271 is illustrated as being received from user 252, and in other approaches the request may be received from a running application, a controller, etc. Details that may be included in the received request 271 are also illustrated in window 273 according to one example which is in no way intended to be limiting. The request 271 is received by the mutating admission application 258 running in the API server 256, before being transferred to the hyper protect virtual machine based container 260. Accordingly, one or more instructions are sent from a mutating admission application 258 running in the API server 256, to the hyper protect virtual machine based container 260 that result in (e.g., cause) the webhook 262 initiating the decryption of the data in the identified secret deployment request.

Proceeding to operation (7), a new pod 272 is deployed, and a container 274 is injected into the newly deployed pod 272. In some approaches, the process of deploying the new pod 272 and/or container 274 involves the API server 256 and/or the hyper protect virtual machine based container 260. In some approaches the container 274 is an init container that may be configured to run before any application containers in the new pod 272, e.g., to perform initialization tasks. It should also be noted that the hyper protect virtual machine based container includes a QEMU copy-on-write 2 (QCOW2) image built in a secure environment at the cloud based application system in preferred approaches (e.g., see FIG. 3B below). The image may thereby secure (e.g., protect) a private key in a cryptographic key pair associated with the hyper protect virtual machine based container.

In response to the new pod 272 and container 274 being deployed, operation (8) includes causing the encrypted secret deployment request (and data therein) to be pulled out of the protected object 268 and injected into the newly deployed pod 272. It follows that the pod 272 includes encrypted details therein. Operation (9) thereby includes causing the encrypted secret deployment request in pod 272 to be decrypted.

Accordingly, one or more instructions may be sent from the mutating admission application 258 running in the API server 256, to the hyper protect virtual machine based container 260. The one or more instructions may result in (e.g., cause) the webhook 262 in the hyper protect virtual machine based container 260 to decrypt data in the received pod 272 using the specific private key 264 that is correlated with the user 252 that originally issued the secret deployment request 254. For instance, the webhook 262 may work in combination with a decryption engine to reproduce the original decrypted secret deployment request 254. In some approaches, the private key assigned to user 252 and which was used to originally encrypt the secret deployment request 254 may be stored in an encrypted form. For instance, the private key may be encrypted using a public key in a cryptographic key pair that is assigned to the hyper protect virtual machine based container 260. Thus, each of the user specific private keys may be stored in a protected form while not in use, thereby further improving data security and retention, e.g., as would be appreciated by one skilled in the art after reading the present description.

It follows that system 250 is able to provide a cloud native process of protecting user sensitive data. This is true even in systems that implement software that is used at least in part to deploy containerized applications (e.g., such as KUBERNETES), which has been particularly difficult for conventional products to achieve. Moreover, FIG. 3A illustrates a flowchart of a method 300 for improving the security of sensitive data in accordance with one approach. One or more of the operations in method 300 may thereby be performed in some approaches to implement user specific (e.g., user owned) encryption keys to encrypt user sensitive data for the respective users. In other words, user sensitive data is encrypted by private encryption keys that are specific to the respective users that produced (e.g., owned, possessed, etc.) the user sensitive data. This desirably increases security of the user sensitive data, particularly in comparison to conventional issues experienced by storing sensitive data with inadequate or even nonexistent protection, e.g., as will be described in further detail below.

The method 300 may be performed in accordance with the present invention in any of the environments depicted in FIGS. 1-2B, among others, in various approaches. Of course, more or less operations than those specifically described in FIG. 3A may be included in method 300, as would be understood by one of skill in the art upon reading the present descriptions.

Accordingly, each of the steps of the method 300 may be performed by any suitable component of the operating environment. For example, one or more of the operations in method 300 may be performed by a processor at an edge node (e.g., see edge node 206 of FIG. 2B) and/or a processor at a central location (e.g., see central server 202). In other approaches, the method 300 may be partially or entirely performed by a controller, a computer, etc., or some other device having one or more processors therein. Thus, in some approaches, method 300 may be a computer-implemented method. Moreover, the terms computer, processor and controller may be used interchangeably with regards to any of the approaches herein, such components being considered equivalents in the many various permutations of the present invention.

For those approaches having a processor, the processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown, operation 302 of method 300 includes receiving a secret deployment request having sensitive data therein, from a user. In some approaches, the secret deployment request is intended for (e.g., targets) resources that are included in a given server. For example, the user may be a resource owner that is preauthorized to access certain resources at a server. In response to receiving the access request, method 300 advances to operation 304. There, operation 304 includes causing the received secret deployment request to be encrypted using a private key that is correlated with the user. In other words, operation 304 includes encrypting the secret deployment request and any sensitive data therein using a private encryption key that is assigned to the specific user that submitted the request. In some approaches, the process of causing the secret deployment request to be encrypted using the user specific private key includes sending one or more instructions to the hyper protect virtual machine based container. The one or more instructions ultimately cause a webhook in the hyper protect virtual machine based container to encrypt data in the secret deployment request using the private key correlated with the user. Again, this increases the security of the sensitive data by ensuring that each user is only able to access the requests and data that have been encrypted using their respective private key.

In some approaches, the user specific private cryptographic key may be received from the user along with the secret deployment request. In other approaches, an encryption engine may be used to generate and/or receive cryptographic keys for one or more respective users. A unique cryptographic private key may thereby be assigned to each user and used to encrypt sensitive data associated with the respective user. In some implementations, the user specific keys are stored and/or managed in a secure software environment at an edge node. In other implementations, the user specific keys may be generated at an edge node and transmitted to a central server for storage, management, review, etc.

From operation 304, method 300 advances to operation 306. There, operation 306 includes causing an encrypted version of the private key correlated with the user to be stored in a hyper protect virtual machine based container. In other words, operation 306 includes sending one or more instructions that cause the user specific private key that was used to encrypt the received secret deployment request, to itself be encrypted or otherwise hardened (e.g., protected). According to some approaches, the user specific private key may be encrypted using cryptographic information from a cryptographic key pair assigned to the hyper protect virtual machine based container. For example, a public key from the cryptographic key pair assigned to the hyper protect virtual machine based container may be used to encrypt each of the user specific keys. This allows for the private key of the cryptographic key pair assigned to the hyper protect virtual machine to be used to decrypt the user specific key, e.g., in response to receiving a request to access the secret deployment request that was encrypted using the user specific key.

From operation 306, method 300 advances to operation 308. There, operation 308 includes causing the encrypted secret deployment request to be stored in memory. As noted above, the encrypted secret deployment request is preferably stored in memory of a system having a cloud based application environment. In some approaches, the cloud based application environment implements a KUBERNETES platform. However, the system may utilize any desired type of containerized applications in other implementations. It follows that in some approaches the memory includes a key-value store. For example, the memory may be an etcd.

It follows that the operations of method 300 are desirably able to provide a cloud native method to protect user sensitive data. Again, by implementing user specific keys to encrypt different sensitive data, approaches herein significantly improve data security. It follows that sensitive data corresponding to a given user is encrypted by a user specific key (e.g., a user specific private key) before the sensitive data is stored in memory. This allows for sensitive data to be cryptographically protected in a manner that is unique to each user, thereby desirably increasing data security. The keys assigned to the respective users are also protected in a hyper protect secret service virtual machine based container that may further be running in a secure execution environment. Accordingly, only the proper user and other authorized entities (e.g., users, applications, controllers, processors, etc.) are able to access a respective one of the user owned keys from the hyper protect secret service virtual machine based container.

Referring momentarily now to FIG. 3B, the process of securing the various keys that are used to encrypt and decrypt a secret deployment request (and any sensitive data therein) is illustrated in accordance with one exemplary approach, e.g., which may be combined with any of the other approaches herein. As shown, a cryptographic key pair 350 that corresponds to the hyper protect secret service virtual machine based container is generated. This key pair may be generated automatically in response to the hyper protect secret service virtual machine based container being initialized in some approaches.

The public key in the key pair 350 is made accessible to a user 352. For example, the public key may be published such that it may be accessed by any desired user. As noted above, this public key may be used to encrypt a user specific key before being stored in an image. Moreover, the private key in the key pair 350 is stored in a Bootloader initrd of the QCOW2 image. In some approaches, the QCOW2 image is built in the hyper protect virtual machine based container. Moreover, the QCOW2 image includes a Bootloader initrd. The process of storing the private key in the Bootloader initrd involves encrypting the private key using an image key 354. For instance, the image key may be used to encrypt the private key itself and/or the bootload initrd of the QCOW2 image, thereby restricting access and protecting the private key.

In response to encrypting the private key using the image key 354, the image key 354 is sent to a secure execution header in the QCOW2 image. Moreover, the host public key 356 (e.g., corresponding to a host of the system, user 352, or another verified entity) is used to encrypt the image key 354 before or after being inserted into the secure execution header. Thus, the image key cannot be accessed by unverified users, and any private keys cannot be exposed or otherwise accessed.

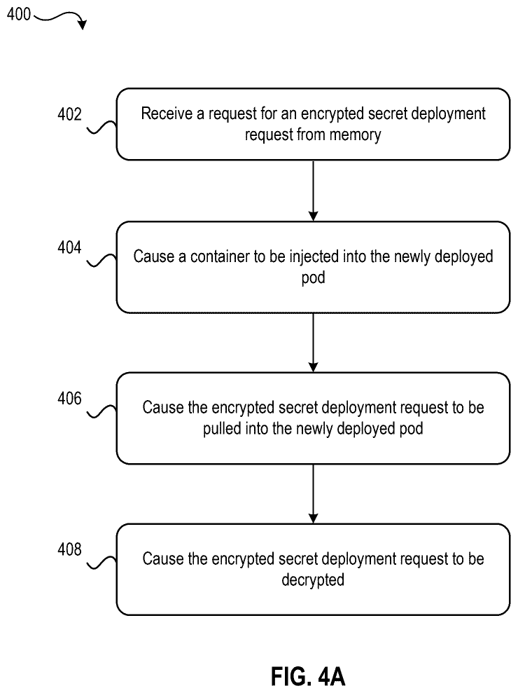

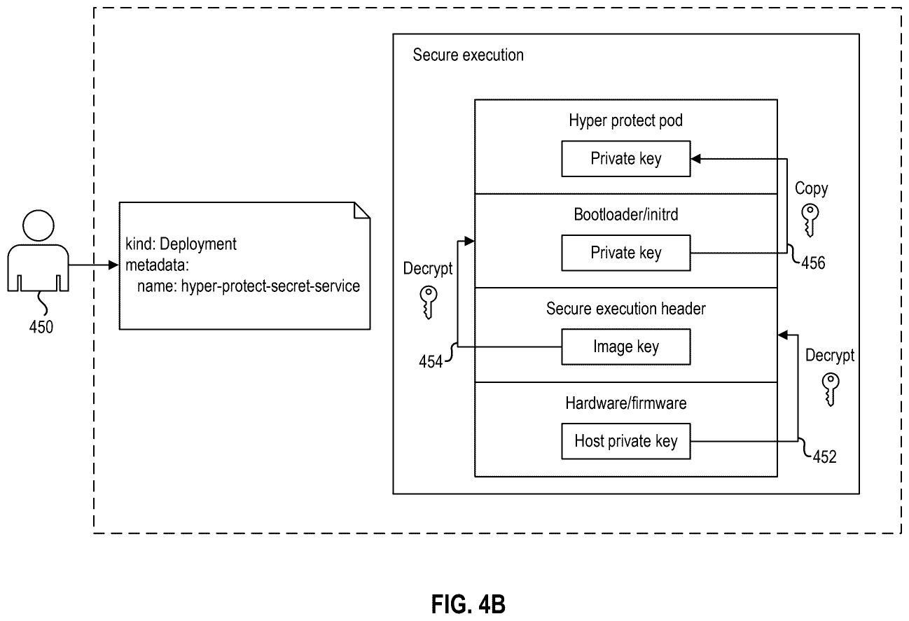

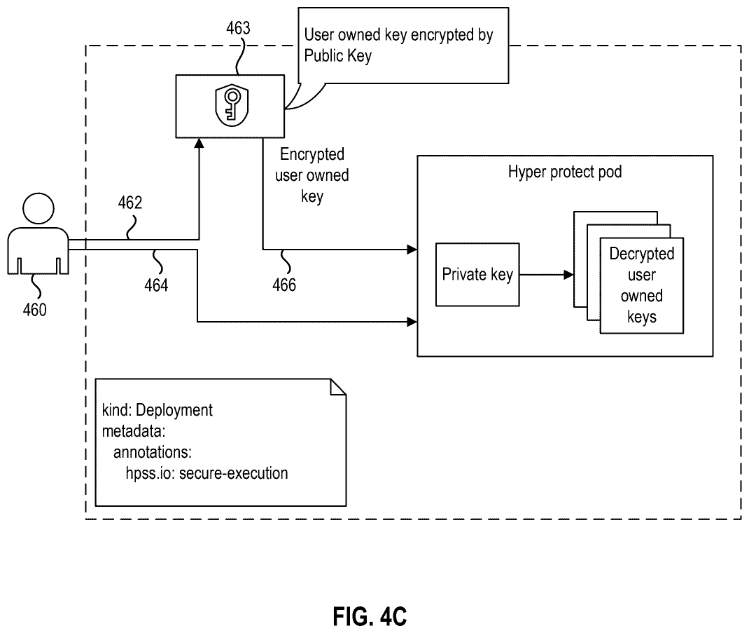

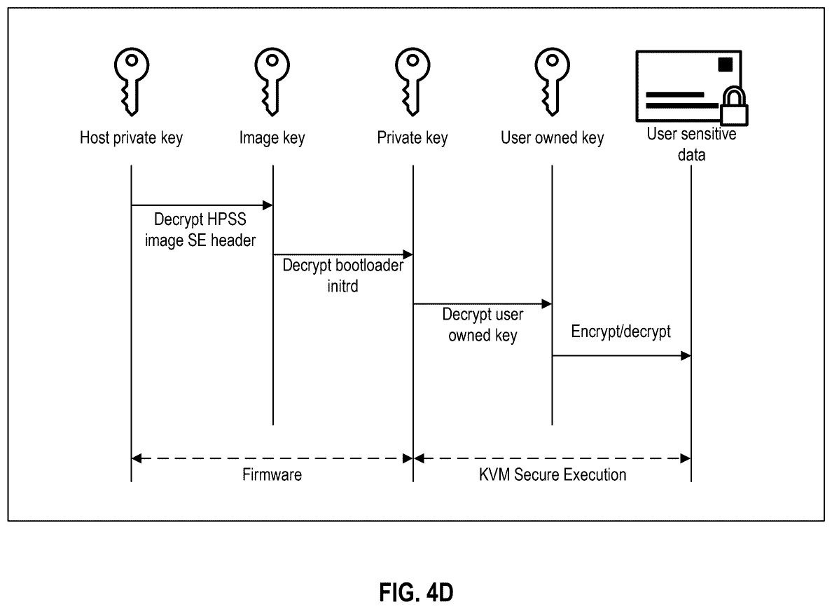

Similarly, the user specific keys are applied while retrieving encrypted sensitive data from memory. For instance, FIG. 4A illustrates a flowchart of a method 400 for improving the security of sensitive data in accordance with another approach. One or more of the operations in method 400 may thereby be performed in some approaches to implement user specific (e.g., user owned) encryption keys to decrypt user sensitive data. In other words, encrypted user sensitive data is decrypted using the same private encryption keys that are specific to the respective users that produced (e.g., owned, possessed, etc.) the user sensitive data. This desirably increases security of the user sensitive data, particularly in comparison to conventional issues experienced by storing sensitive data with inadequate or even nonexistent protection, e.g., as will be described in further detail below.

The method 400 may be performed in accordance with the present invention in any of the environments depicted in FIGS. 1-2B, among others, in various approaches. Of course, more or less operations than those specifically described in FIG. 3A may be included in method 400, as would be understood by one of skill in the art upon reading the present descriptions.

Accordingly, each of the steps of the method 400 may be performed by any suitable component of the operating environment. For example, one or more of the operations in method 400 may be performed by a processor at an edge node (e.g., see edge node 206 of FIG. 2B) and/or a processor at a central location (e.g., see central server 202). In other approaches, the method 400 may be partially or entirely performed by a controller, a computer, etc., or some other device having one or more processors therein. Thus, in some approaches, method 400 may be a computer-implemented method. Moreover, the terms computer, processor and controller may be used interchangeably with regards to any of the approaches herein, such components being considered equivalents in the many various permutations of the present invention.

For those approaches having a processor, the processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As shown, operation 402 of method 400 includes receiving a request for an encrypted secret deployment request from memory. In some approaches, the received request is a pod deployment request. The request may be received from the respective user that originally encrypted and stored the secret deployment request in the memory. It follows that some user identifying information may be received along with the request in operation 402, where the user identifying information may be used to verify authenticity of the request, the user issuing the request, identify a corresponding encrypted secret deployment request, etc.

In response to receiving the request, method 400 advances to operation 402. There, operation 402 includes causing a new pod to be deployed, while operation 404 includes causing a container to be injected into the newly deployed pod. It follows that operations 402 and 404 prepare a logical location for the requested secret deployment request (and corresponding sensitive data) to be sent from memory. Moreover, this may be achieved in some approaches by an API server sending one or more instructions that result in the new pod and injected container to be formed. For instance, one or more instructions may be sent from a mutating admission application running in the API server, to the hyper protect virtual machine based container. The one or more instructions ultimately cause a webhook in the hyper protect virtual machine based container to inject the init container into the newly deployed pod.

Furthermore, operation 406 includes causing the encrypted secret deployment request to be pulled into the newly deployed pod. This may be achieved by sending one or more instructions to memory that identify the requested secret deployment request. The one or more instructions may also identify the user specific key associated with decrypting the requested secret deployment request. Accordingly, proceeding to operation 408, the method 400 includes causing the encrypted secret deployment request to be decrypted.

Again, the process of decrypting the secret deployment request involves the user specific key that was used to encrypt it. Thus, performing operation 408 actually includes using the cryptographic key pair associated with the hyper protect virtual machine based container to decrypt the encrypted version of the user specific private key. As noted above, the public key of the cryptographic key pair associated with the hyper protect virtual machine based container is used to encrypt the user specific key. Accordingly, the private key of the cryptographic key pair associated with the hyper protect virtual machine based container may be used to decrypt the user specific key that is stored in the hyper protect virtual machine based container. In response to decrypting the user specific key, the decrypted version of the user specific key may be used to decrypt the secret deployment request and sensitive data therein.

Referring momentarily now to FIG. 4B, the process of performing a secret pod deployment is illustrated in accordance with one exemplary approach, e.g., which may be combined with any of the other approaches herein. As shown, an administrator 450 sends one or more instructions that result in a hyper protect virtual machine pod (e.g., the hyper protect secret service virtual machine based container) with secure execution enabled being deployed. In some approaches, the administrator 450 is a KUBERNETES cluster administrator.

In response to the hyper protect virtual machine pod being deployed, one or more instructions are sent that result in firmware loading the QCOW2 image and using the host private key stored therein to decrypt Secure Execution Header. See operation 452. This decryption step allows for the image key to be released. Proceeding to operation 454, firmware uses the image key to in turn decrypt Bootloader initrd, thereby releasing the Private key of the cryptographic key pair that corresponds to the hyper protect virtual machine based container. Furthermore, the bootloader copies the now accessible Private key and sends the copy to the hyper protect virtual machine pod root filesystem. See operation 456. The Private key may thereby be used as desired, e.g., to encrypt and/or decrypt further logical items.

Proceeding now to FIG. 4C, the process of performing a user specific key deployment is illustrated in accordance with another exemplary approach, e.g., which may be combined with any of the other approaches herein. Initially, a user 460 encrypts user owned secret encryption key (user specific key) using the public key of the key pair that is assigned to the hyper protect secret service virtual machine based container. In response to the user specific key being encrypted, the user 460 deploys the encrypted user specific key in a protected object 463. See operation 462. In preferred approaches, the protected object 463 is a KUBERNETES Secret configured to prevent unauthorized access to the encrypted details therein.

Proceeding to operation 464, an access request is sent from user 460 to the hyper protect virtual machine pod. In response to receiving the request, the hyper protect virtual machine pod receives the encrypted user owned key from the protected object 463. See operation 466. As a result, the hyper protect virtual machine pod is able to decrypt the encrypted user specific key using the private key of the key pair that is assigned to the hyper protect secret service virtual machine based container. However, the private key of the key pair is encrypted and built into a corresponding image, e.g., as described herein. Accordingly, the private key of the key pair may be decrypted at boot time, and transferred into the hyper protect virtual machine pod root filesystem. As a result, the private key of the key pair is ultimately used to decrypt the user owned (also referred to as “user specific”) key(s).

Referring now to FIG. 4D, the process of accessing encrypted sensitive data is illustrated in accordance with yet another approach, e.g., which may be combined with any of the other approaches herein. As shown, a host private key may be provided by an administrator that has permission to access the image being used to store a desired image key, e.g., as described herein. In response to receiving the host private key, firmware uses this key to decrypt the image SE header, thereby releasing the decrypted Image key. The Image key is thereby used by firmware to decrypt the bootloader initrd. This decryption of the bootloader initrd desirably allows for the private key of the key pair associated with the hyper protect virtual machine based container to be released.

In response to receiving access to the decrypted private key of the key pair, this private key may thereby be used in a keyboard-video-mouse (KVM) secure execution environment to in turn decrypt the user owned key. Furthermore, the decrypted user owned key may be used in the KVM secure execution environment to encrypt and/or decrypt desired user sensitive data which corresponds to the user owned key.

It follows that approaches herein are desirably able to protect user specific cryptographic keys in a hyper protect image. As noted above, in some approaches the hyper protect image is a QCOW2 image that is built in a secure environment. The hyper protect image may also include the private key in the key pair that is associated with the hyper protect secret service virtual machine based container. Moreover, the initrd and bootloader may be encrypted by an image key that is generated automatically in the secure build environment. This image key may also be encrypted by a host (e.g., administrator) public key and built into the execution header of the QCOW2 image (e.g., see FIG. 3B). In one example, the hyper protect image is a Hyper Protect Service virtual machine image that is deployed in a KUBERNETES cluster and runs in a secure execution environment.

The hyper protect image header may further be loaded by host firmware and decrypted with the host private key. For instance, the hyper protect QCOW2 image initrd and bootloader may be decrypted by host firmware applying the image key. The hyper protect QCOW2 image root filesystem is further loaded by the bootloader, and the corresponding private key is injected into the root filesystem. The hyper protect secret service virtual machine based container runs in a secure execution environment. Moreover, a user owned key is preferably encrypted by the user applying the public key of the key pair that corresponds to the hyper protect secret service virtual machine based container, before the user key is deployed. However, the user owned key is decrypted in the hyper protect secret service virtual machine based container using the private key of the key pair. It follows that user sensitive data is encrypted by user owned key(s) in memory, thereby improving data security and retention.

According to some approaches, a webhook running in the hyper protect secret service virtual machine based container is invoked when user sensitive data is deployed in a KUBERNETES Secret with hyper-protect-secret enabled (e.g., via annotations). Thus, user sensitive data is encrypted by the respective user owned key in the hyper protect secret service virtual machine based container before being stored in memory. User sensitive data is further decrypted using an init container in a user deployed Pod. An init container is also injected into the user deployed Pod. The init container sends request to hyper protect secret service virtual machine based container on Pod starting to decrypt user sensitive data that is received from KUBERNETES Secrets. The hyper protect secret service virtual machine based container further decrypts the user sensitive data using user owned key and the decrypted user sensitive data is returned.

Approaches herein are thereby able to protect sensitive data in KUBERNETES Secrets by encrypting the sensitive data with user specific keys, thereby preventing unauthorized access to the sensitive data. The user owned key(s) are further protected in a secure execution environment that prevents any other users from accessing other users'keys. Moreover, running in a secure execution environment enables the deployment of sensitive containerized workloads in a highly isolated environment with technical assurance.

It will be clear that the various features of the foregoing systems and/or methodologies may be combined in any way, creating a plurality of combinations from the descriptions presented above.

It will be further appreciated that implementations of the present invention may be provided in the form of a service deployed on behalf of a customer to offer service on demand.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

What is claimed is:

1. A method, comprising:
receiving a secret deployment request from a user;
causing the secret deployment request to be encrypted using a private key correlated with the user;
causing an encrypted version of the private key correlated with the user to be stored in a hyper protect virtual machine based container; and
causing the encrypted secret deployment request to be stored in memory.

2. The method of claim 1, wherein the causing the secret deployment request to be encrypted using a private key correlated with the user includes:
sending one or more instructions to the hyper protect virtual machine based container, the one or more instructions causing a webhook to encrypt data in the secret deployment request using the private key correlated with the user.

3. The method of claim 1, wherein the causing the encrypted version of the private key correlated with the user to be stored in the hyper protect virtual machine based container includes:
causing the private key correlated with the user to be encrypted using a public key in a cryptographic key pair associated with the hyper protect virtual machine based container.

4. The method of claim 1, further comprising:
receiving a request for the encrypted secret deployment request;
causing an init container to be injected into a newly deployed pod;
causing the encrypted secret deployment request to be pulled into the newly deployed pod; and
causing the encrypted secret deployment request to be decrypted.

5. The method of claim 4, wherein decrypting the encrypted secret deployment request includes:
using a private key in a cryptographic key pair associated with the hyper protect virtual machine based container to decrypt the encrypted version of the private key correlated with the user; and
using the decrypted version of the private key correlated with the user to decrypt data in the encrypted secret deployment request.

6. The method of claim 4, wherein the causing the init container to be injected into the newly deployed pod includes:
sending one or more instructions to the hyper protect virtual machine based container, the one or more instructions causing a webhook to inject the init container into the newly deployed pod.

7. The method of claim 1, wherein the memory includes a key-value store, wherein the secret deployment request is received from the user at an API server of a cloud based application system.

8. The method of claim 7, wherein the hyper protect virtual machine based container includes an image built in a secure environment at the cloud based application system.

9. The method of claim 8, wherein the image secures a private key in a cryptographic key pair associated with the hyper protect virtual machine based container.

10. A computer program product, comprising:
one or more computer-readable storage media; and
program instructions stored on the one or more storage media to perform operations comprising:
receiving a secret deployment request from a user;
causing the secret deployment request to be encrypted using a private key correlated with the user;
causing an encrypted version of the private key correlated with the user to be stored in a hyper protect virtual machine based container; and
causing the encrypted secret deployment request to be stored in memory.

11. The computer program product of claim 10, wherein the causing the secret deployment request to be encrypted using a private key correlated with the user includes:
sending one or more instructions to the hyper protect virtual machine based container, the one or more instructions causing a webhook to encrypt data in the secret deployment request using the private key correlated with the user.

12. The computer program product of claim 10, wherein the causing the encrypted version of the private key correlated with the user to be stored in the hyper protect virtual machine based container includes:
causing the private key correlated with the user to be encrypted using a public key in a cryptographic key pair associated with the hyper protect virtual machine based container.

13. The computer program product of claim 10, wherein the operations further comprise:
receiving a request for the encrypted secret deployment request;
causing an init container to be injected into a newly deployed pod;
causing the encrypted secret deployment request to be pulled into the newly deployed pod; and
causing the encrypted secret deployment request to be decrypted.

14. The computer program product of claim 13, wherein decrypting the encrypted secret deployment request includes:
using a private key in a cryptographic key pair associated with the hyper protect virtual machine based container to decrypt the encrypted version of the private key correlated with the user; and
using the decrypted version of the private key correlated with the user to decrypt data in the encrypted secret deployment request.

15. The computer program product of claim 13, wherein the causing the init container to be injected into the newly deployed pod includes:
sending one or more instructions to the hyper protect virtual machine based container, the one or more instructions causing a webhook to inject the init container into the newly deployed pod.

16. The computer program product of claim 10, wherein the memory includes a key-value store, wherein the secret deployment request is received from the user at an API server of a cloud based application system.

17. The computer program product of claim 16, wherein the hyper protect virtual machine based container includes an image built in a secure environment at the cloud based application system.

18. The computer program product of claim 17, wherein the image secures a private key in a cryptographic key pair associated with the hyper protect virtual machine based container.

19. A computer system, comprising:
a processor set;
one or more computer-readable storage media; and
program instructions stored on the one or more storage media to cause the processor set to perform operations comprising:
receiving a secret deployment request from a user;
causing the secret deployment request to be encrypted using a private key correlated with the user;
causing an encrypted version of the private key correlated with the user to be stored in a hyper protect virtual machine based container; and
causing the encrypted secret deployment request to be stored in memory.

20. The computer system of claim 19, wherein the operations further comprise:
receiving a request for the encrypted secret deployment request;
causing an init container to be injected into a newly deployed pod;
causing the encrypted secret deployment request to be pulled into the newly deployed pod; and
causing the encrypted secret deployment request to be decrypted,
wherein decrypting the encrypted secret deployment request includes:
using a private key in a cryptographic key pair associated with the hyper protect virtual machine based container to decrypt the encrypted version of the private key correlated with the user, and
using the decrypted version of the private key correlated with the user to decrypt data in the encrypted secret deployment request.
